(19) United States
(12) Patent Application Publication
(10) Pub. No.: US 2015/0113243 A1
(43) Pub. Date: Apr. 23, 2015

(54) METHOD FOR BACKING UP DATA OUTSIDE A SECURE MICROCIRCUIT

(71) Applicant: INSIDE SECURE, Meyreuil (FR)

(72) Inventors: Vincent Dupaquis, Biver (FR); Alexandre Venelli, Aix en Provence (FR)

(21) Appl. No.: 14/396,428

(22) PCT Filed: May 6, 2013
(86) PCT No.: PCT/FR2013/051004

§ 371 Date: Oct. 23, 2014

(30) Foreign Application Priority Data
Jun. 12, 2012 (FR) 1201677

(51) Int. Cl. G06F 12/14

(52) U.S. Cl. CPC G06F 12/1466
USPC 711/164

(57) ABSTRACT

The present invention relates to a method for managing the memory of a secure microcircuit, including steps executed by the microcircuit of: forming a data block with executable code and/or data stored in a volatile memory of the microcircuit, and to be backed up outside the microcircuit, calculating a signature of the data block using a first signature key, inserting the calculated signature of the data block into a signature block, obtaining a current value of a non-volatile counter internal to the microcircuit, calculating a signature of the signature block associated with the current value of the internal counter, using a second signature key, and sending outside the microcircuit, the data block, the signature block and the signature of the signature block.

present invention generally relates to secure microcircuits such as those integrated into smart cards and portable objects such as mobile telephones, tablets and laptop computers, integrating such smart cards.

The present invention applies in particular to smart cards used to secure sensitive transactions such as contact or contactless payment or service access transactions, for example via Near Field Communication (NFC) or Bluetooth.

Microcircuits generally comprise a processor and a rewritable non-volatile memory to store in particular the program executed by the processor and data to be kept between two transactions. This non-volatile memory, generally of EEPROM or Flash type, is quite expensive to manufacture, compared to the processor, and occupies a large surface area of the microcircuit or involves specific manufacturing techniques.

It may therefore be desirable to propose a microcircuit without any rewritable non-volatile memory or with such a non-volatile memory, but with low capacity, i.e. that is insufficient to store the operating system executed by the processor of the microcircuit, and data that must be kept when the microcircuit is switched off. The programs and data that must be kept can be stored outside the microcircuit, for example in a non-volatile memory of the device into which the microcircuit is integrated. When the microcircuit is switched on, the programs and data stored outside the microcircuit can be loaded into a volatile memory of the microcircuit.

However, backing up programs and data outside the microcircuit raises difficulties, in particular security problems. Indeed, microcircuits in smart cards may store secret data such as identifiers and ciphering keys. Furthermore, in certain sensitive applications such as payment applications or applications for controlling access to a pay-for service, the programs executed by these microcircuits are generally certified by authorized organizations. As the external memory wherein the programs and data to be backed up would be stored is not necessarily secured, nor coupled to the microcircuit by a secure link, it can therefore be necessary to ensure the confidentiality and/or integrity of the data and programs backed up outside the microcircuit. For this purpose, provision may be made for ciphering and/or signing the programs and data to be backed up before sending them outside the microcircuit. Therefore, the processor must have a secret ciphering key. In the absence of any non-volatile memory, this secret key cannot be kept by the microcircuit if the latter is switched off, to be able to decipher programs and data received or to check signatures.

This solution also raises security problems, when it comes in particular to controlling or limiting a number of operations authorized to be executed by the microcircuit. This problem arises when the microcircuit must only be able to execute a limited number of transactions, for example in the framework of payment applications or applications for controlling access to a place or a service (for example downloading games or music). Indeed, if the transaction data is stored outside the microcircuit, even in a ciphered form, a so-called “replay” attack can involve replacing a last ciphered data block with an older ciphered data block, sent by the microcircuit. In the absence of any rewritable non-volatile memory, the microcircuit cannot determine whether or not a ciphered data block received corresponds to the last data block it sent to be backed up in an external non-volatile memory, or to an older block.

Furthermore, volatile memories provided in microcircuits may have a large capacity. Backing up the entire volatile memory can therefore require immobilizing the microcircuit for a considerable period of time. This period of time may be further increased if the backup is interrupted before it ends and must be executed again. This period of time can also affect the ease of use of the microcircuit. It may therefore be difficult to envisage backing up the entire volatile memory before each switch-off of the microcircuit or even worse, every time the content of this memory is changed.

It may therefore be desirable to propose a microcircuit in which the rewritable non-volatile memory, which can in particular be of Flash, EEPROM, MRAM (Magnetic RAM), and battery-backed RAM type, is removed and replaced with an OTP (One-Time Programmable) non-volatile memory, or is limited to a low capacity, insufficient to store the program(s) executed by the microcircuit and data to be kept between two sessions of microcircuit use. It may be also desirable for this removal or limitation of the rewritable non-volatile memory not to affect the security of the microcircuit. It may also be desirable not to have to systematically back up the entire content of the volatile memory outside the microcircuit in one go.

Some embodiments relate to a method for managing the memory of a secure microcircuit, comprising steps executed by the microcircuit of: forming a data block with executable code and/or data stored in a memory of the microcircuit, and to be backed up outside the microcircuit, calculating a signature of the data block using a first signature key, inserting the calculated signature of the data block into a signature block formed with signatures of data blocks sent outside the microcircuit, obtaining a current value of a non-volatile counter internal to the microcircuit, calculating a signature of the signature block associated with the current value of the internal counter, using a second signature key, and sending outside the microcircuit, the data block, the signature block and the signature of the signature block.

According to one embodiment, the method comprises steps executed by the microcircuit of: sending a request for a signature block, receiving in response a signature block together with a signature, calculating a signature of the signature block associated with the current value of the internal counter, using the second signature key, and if the calculated signature corresponds to the signature received: forming a data block with executable code and/or data stored in the volatile memory of the microcircuit, and to be backed up outside the microcircuit, calculating a signature of the data block, using the first signature key, inserting the calculated signature of the data block into the signature block, changing the current value of the internal counter, calculating a new signature of the signature block associated with the new value of the internal counter, using the second signature key, and sending outside the microcircuit, the data block, the signature block and the new signature of the signature block.

According to one embodiment, the method comprises steps of: if the calculated signature of the signature block corresponds to the signature received: sending a request for a data block backed up outside the microcircuit, receiving in response the requested data block, calculating a signature of the data block received, using the first signature key, and if the calculated signature of the data block corresponds to a signature of the data block located in the signature block, loading the data block into the volatile memory of the microcircuit.

According to one embodiment, the method comprises a step of breaking down the volatile memory of the microcircuit into data blocks which may be backed up outside the microcircuit, in association with a signature of the data block, backed up in the signature block.

According to one embodiment, the first and second signature keys are read in a non-volatile memory of the microcircuit or regenerated from a secret datum supplied by a circuit of the microcircuit.

According to one embodiment, the first and second signature keys are identical.

According to one embodiment, the method comprises a step of ciphering a data block or the signature block, using a ciphering key, before sending it outside the microcircuit.

According to one embodiment, the ciphering key is identical to the first or the second signature key.

According to one embodiment, each block is signed and/or ciphered with a signature or ciphering key different from the signature and/or ciphering keys used for the other blocks.

According to one embodiment, each signature key is generated from a secret datum obtained by an unclonable, substantially deterministic, non-invertible function (PUF) characteristic of the microcircuit, which, when combined with an error correction function or an averaging function, always provides the same secret datum.

According to one embodiment, the generation of each signature key comprises steps of: generating a random datum and an error correction datum from the random datum, generating the signature key from the random datum, obtaining a first secret datum from an unclonable, substantially deterministic, non-invertible function characteristic of the microcircuit, and combining by a first invertible logic function the first secret datum and the random datum, to obtain a datum exportable outside the microcircuit, the regeneration of each signature key comprising steps of: obtaining a second secret datum from the function characteristic of the microcircuit, and combining by a second logic function that is the inverse of the first logic function, the second secret datum and the exportable datum, applying to the result of the second logic function an error correction process using the error correction datum, to obtain the random datum, and generating the signature key from the random datum.

According to one embodiment, the generation of each signature key comprises steps of: obtaining a third secret datum from the function characteristic of the microcircuit, and combining by the first logic function, the third secret datum and the error correction datum, to obtain a second exportable datum, the regeneration of each signature key comprising steps of: obtaining a fourth secret datum from the function characteristic of the microcircuit, and combining by the second logic function, the fourth secret datum and the second exportable datum, to obtain an error correction datum that is used by the error correction process, to obtain the random datum.

According to one embodiment, the method comprises a step of changing bits in the secret data supplied by the function characteristic of the microcircuit, by inserting random bits or inverting bits into the secret data, the extent of the bit changes in the secret data being such that they can be corrected by the error correction function.

Some embodiments also relate to a microcircuit comprising a processor and a volatile memory in which a program executed by the processor is stored, the microcircuit being configured to implement the method as described above.

According to one embodiment, the microcircuit comprises a rewritable, non-volatile storage capacity that is insufficient to store the programs or the operating system executed by the microcircuit.

According to one embodiment, the microcircuit comprises a circuit implementing an unclonable, substantially deterministic, non-invertible function characteristic of the microcircuit.

Some examples of embodiments of the present invention will be described below in relation with, but not limited to, the following figures, in which:

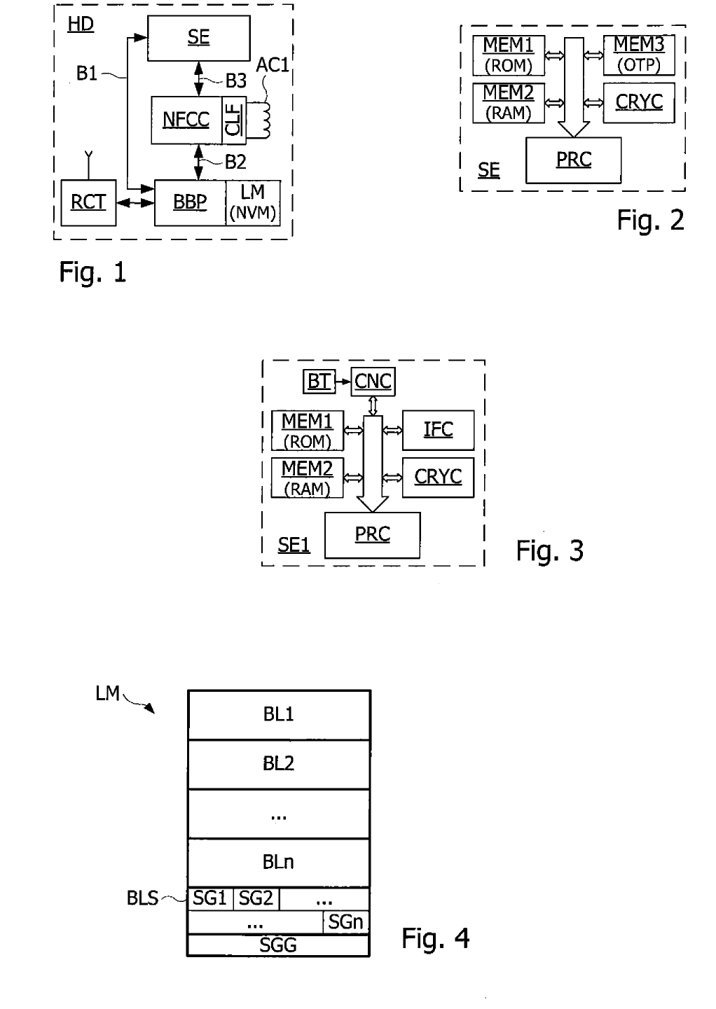

FIG. 1 schematically represents a portable device comprising a secure microcircuit,

FIGS. 2 and 3 schematically represent circuits of the secure microcircuit, according to some embodiments,

FIG. 4 represents a data structure, according to one embodiment,

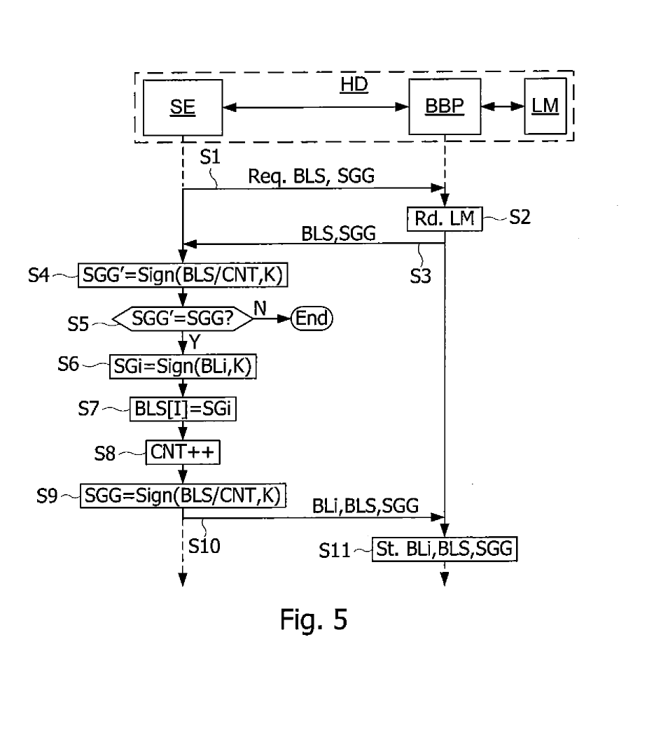

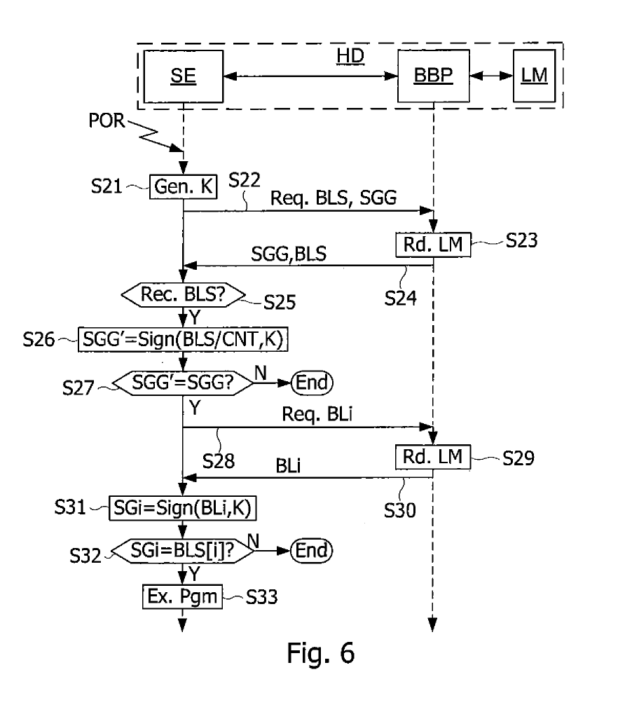

FIGS. 5 and 6 represent steps executed during the execution of a program by the secure microcircuit, and when switching on the microcircuit, according to some embodiments,

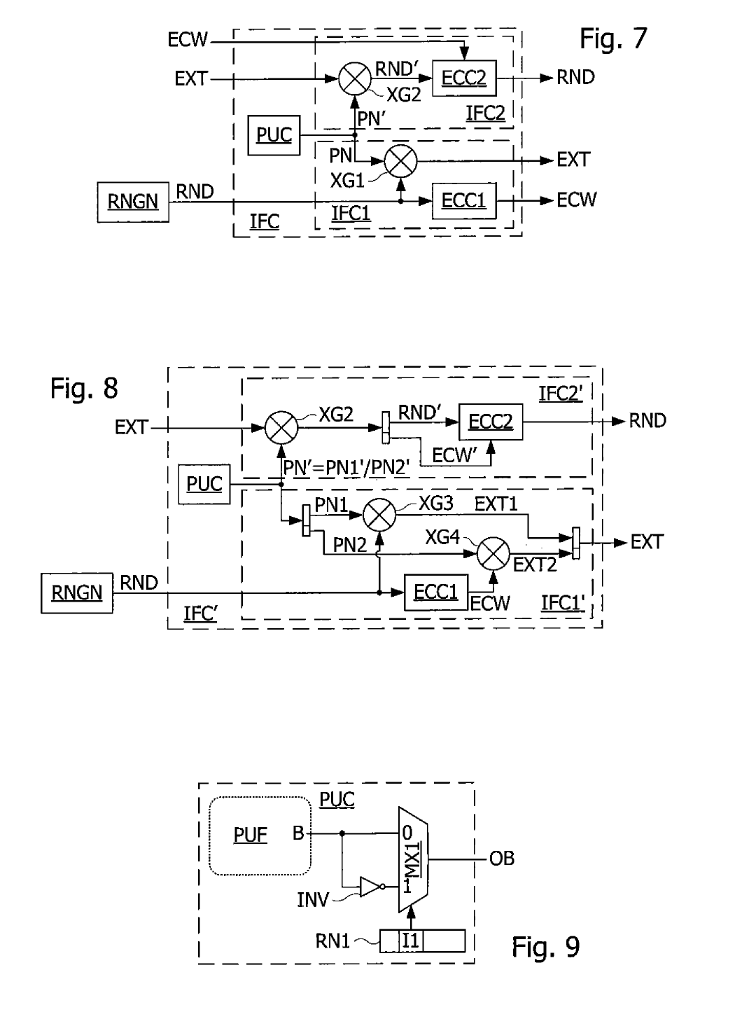

FIGS. 7 and 8 schematically represent circuits for generating a same secret datum which can be used as encryption key or master key to generate encryption keys,

FIG. 9 schematically represents a circuit of the microcircuit according to one embodiment.

FIG. 1 represents a portable device HD, such as a mobile telephone, equipped with a near field communication interface. The device HD comprises for example a main processor BBP, also referred to as base-band processor, a radiocommunication circuit RCT connected to the processor BBP, and a secure microcircuit SE coupled to the processor BBP. The microcircuit SE can be of UICC type (“Universal Integrated Circuit Card”), for example of mini-SIM, micro-SIM or micro-SD type.

The portable device HD can for example be of near field communication type NFC, equipped with a near field communication interface. Thus, the portable device may also comprise an NFC controller, referenced NFCC, which is coupled to the processor BBP by a link B2, an antenna circuit AC1 connected to the controller NFCC. The microcircuit SE can be coupled to the controller NFCC by a link B3. The microcircuit SE can be configured to perform NFC transactions with a transaction terminal (not represented) through the controller NFCC. The controller NFCC comprises a contactless communication interface CLF connected to the antenna circuit AC1. The controller NFCC may have the form of an integrated circuit, such as MicroRead® marketed by the Applicant.

The device HD may also comprise another secure processor, for example integrated into a SIM (“Subscriber Identity Module”) card, as well as a non-volatile memory card, such as a Micro SD (“Micro Secure Digital”) card. The microcircuit SE which is for example integrated into a card, can be coupled to the processor BBP by a link B1.

FIG. 2 represents circuits of the microcircuit SE. The microcircuit SE comprises a processor PRC, and memories MEM1, MEM2 and cryptographic calculation circuits CRYC, connected to the processor PRC. The memory MEM1 is for example of ROM type (“Read-Only Memory”) or of one-time programmable type (OTP) and the memory MEM2 is volatile, for example of RAM type (“Random Access Memory”).

According to one embodiment, the microcircuit SE comprises a non-volatile memory MEM3 with a low capacity, for example a few tens of bytes, which can be rewritable, or a one-time programmable memory (OTP). OTP memories can be manufactured at lower cost compared to a Flash- or EEPROM-type memory, by only performing steps of manufacturing CMOS circuits. The memory MEM3 can also be a RAM memory with a low capacity, powered by a dedicated miniaturized battery, when the microcircuit is no longer powered by an external supply voltage source, for example that of the device HD. The battery is recharged when the microcircuit is coupled to an external supply voltage source. Here “low capacity” means with a capacity not sufficient to back up the program or the operating system executed by the processor PRC. The memory MEM3 is used to back up the value of a counter.

FIG. 3 represents a microcircuit SE1 according to another embodiment. The microcircuit SE1 differs from the microcircuit SE in that it does not comprise any non-volatile memory, but a counter produced by a hard-wired logic circuit CNC and a circuit IFC whereby it is possible to generate a same secret datum every time the microcircuit SE1 is switched on. This secret datum can be used as ciphering key or to generate such a key. The circuit CNC can be powered by a dedicated miniaturized battery BT. The battery BT is recharged when the microcircuit is coupled to an external supply voltage source.

It will be understood that the microcircuit SE (FIG. 2) may also comprise a circuit such as the circuit IFC to generate a secret datum likely to be used as a ciphering key or to generate such a ciphering key.

According to one embodiment, one or more programs executed by the microcircuit SE, SE1 and data handled by these programs, located in the memory MEM2 are backed up in an external non-volatile memory, for example a memory LM connected to the processor BBP. FIG. 4 represents a data structure in the memory LM in which the program and data stored in the memory MEM2 of the microcircuit SE, SE1 are backed up. In FIG. 4, the data structure comprises blocks BL1, BL2, . . . BLn and BLS and a signature SGG of the block BLS. The block BLS comprises a signature SG1, SG2, . . . SGn of each of the blocks BL1-BLn.

FIG. 5 represents steps executed by the secure microcircuit SE, SE1, previously put into communication with an external storage memory, for example the memory LM accessible through the processor BBP. These steps are executed by the microcircuit SE, SE1 to back up in the memory LM a block BLi located in the memory MEM2. In a step S1, the microcircuit SE, SE1 sends a request for reading the block BLS and the signature SGG of the block BLS, to the processor BBP. In a step S2, the processor BBP reads the requested information in the memory LM. In a step S3, the processor BBP sends the microcircuit SE, SE1, the block BLS and the signature SGG located in the memory LM. In a step S4, the microcircuit SE, SE1 calculates a signature of the block BLS received, concatenated to the value of the counter CNT read in the memory MEM3 or supplied by the circuit CNC. This signature is calculated using a secret key K, for example stored in the memory MEM3 of the microcircuit SE, or generated using the circuit IFC of the microcircuit SE1. In a step S5, the microcircuit SE, SE1 compares the signature SGG′ obtained in step S4 with the signature SGG received in step S3. The microcircuit SE, SE1 then executes steps S6 to S10 only if the signature SGG′ corresponds to the signature SGG. In step S6, the microcircuit SE, SE1 calculates, using the key K, a signature SGi of the block BLi to be backed up. In step S7, the microcircuit SE, SE1 updates the block BLS by inserting thereinto the signature SGi obtained at the location of the signature of the block BLi. In step S8, the microcircuit increments the value of the counter CNT stored in the memory MEM3 or by the circuit CNC. In step S9, the microcircuit SE, SE1 calculates the signature SGG of the block BLS applied to the block BLS as updated in step S7, concatenated to the new value of the counter CNT obtained in step S8. In step S10, the microcircuit SE, SE1 sends the blocks BLi and BLS and the signature SGG to the processor BBP. In step S11, the processor BBP receives this data and backs it up in the memory LM, possibly to replace the blocks BLi, BLS and the signature SGG that were stored there.

Upon a first backup of a first block BLi in the memory LM, only steps S6, S7 and S9 to S11 are executed. The value of the counter CNT may be zero if the microcircuit executes step S8 for the first time.

In this way, the microcircuit SE, SE1 can use a portion of the external non-volatile memory, such as that of a mobile telephone, which sometimes has a large capacity and is mainly unused.

It shall be noted that the microcircuit SE, SE1 can have a direct access to a non-volatile memory external to the microcircuit. In this case, steps S1 and S9 involve sending requests for reading and writing this external memory.

According to one embodiment, the size of the blocks BLi is defined according to the physical or logic organization of the memory LM or of the memory MEM2. Thus, the size of each block BLi may correspond to the size of a page or of a physical or logical sector of the memory LM or MEM2.

According to another embodiment, the size of the blocks BLi is defined according to the organization of the programs and data in the memory MEM2. Thus, a block BLi may comprise all or part of the program and data of an application installed in the microcircuit. The breakdown of the programs and data stored in the memory MEM2 into blocks BLi can also be determined so as to reduce as far as possible the operations of backing up and restoring a block in the memory MEM2 from the memory LM.

FIG. 6 represents steps executed by the microcircuit SE, SE1 to load into the memory MEM2, a data block BLi stored in the external memory LM. These steps are executed for example upon switching on POR the microcircuit, or when an application stored in the block BLi must be executed. Indeed, it may be provided for the microcircuit SE, SE1, upon switching on, to send a request for loading the first block BL1 which contains the operating system of the processor PRC or a first portion of this operating system, and for the program located in the block BL1 to make it possible to determine which block BLi must also be loaded, according to an application to be executed.

In a step S21, the microcircuit SE, SE1 regenerates the key K using the circuit IFC or reads the latter in the memory MEM3. In a step S22, the microcircuit SE, SE1 sends a request for reading the block BLS and the signature SGG. In a step S23, this request is received and executed by the processor BBP which reads the requested block in the memory LM. In a step S24, the processor BBP sends the block BLS and the signature SGG in response. Such data is received by the microcircuit SE, SE1 in a step S25. In a step S26, the microcircuit SE, SE1 calculates, using the key K, a signature SGG′ of the block BLS concatenated with the current value of a counter CNT read in the memory MEM3 or supplied by the circuit CNC. If the memory MEM3 is of OTP type, the counter CNT can be implemented by managing this memory like an abacus, by changing the state of a bit of the memory every time the value of the counter CNT must be modified. In a step S27, the microcircuit SE, SE1 compares the calculated signature SGG′ with the signature SGG received in step S24. The microcircuit SE, SE1 then executes steps S28 to S33 only if the signature SGG′ corresponds to the signature SGG. In step S28, the microcircuit SE, SE1 sends a request for a block BLi. In a step S29, this request is received and executed by the processor BBP which reads the requested block in the memory LM. In step S30, the processor BBP sends the block BLi in response. In step S31, the microcircuit SE, SE1 receives the block BLi and calculates a signature SGi′ of the block BLi using the key K. In step S32, the microcircuit SE, SE1 compares the calculated signature SGi′ with the signature SGi of the block BLi appearing in the block BLS. The microcircuit SE, SE1 then executes step S33 only if the signatures SGi and SGi′ correspond. In step S33, the microcircuit SE, SE1 loads the block BLi into the memory MEM2. If the block BLi thus loaded comprises a program Pgm, the microcircuit SE, SE1 executes this program. If other blocks BL1-BLn are necessary, the microcircuit can repeat steps S28 and S31 to S32 to load the missing blocks into the memory MEM2 before executing step S33.

In this way, if a block BLi is replaced with an older version of this block, its signature will not correspond to the one in the block BLS. Furthermore, if the block BLS is modified by inserting thereinto the signature of the older block BLi, it is not possible to generate the signature SGG corresponding to the block BLS thus modified without knowing the key K and having full control over the value of the counter CNT. It is thus sufficient to prevent the key K from being accessible from outside the microcircuit, or the counter from being forced to a previous value, to protect the microcircuit against what we refer to as the “playback” of an older program and/or data block BLi that is authentic but which is not the latest block backed up by the microcircuit SE.

It shall be noted that the different values of counter CNT used to calculate the signature SGG are not necessarily consecutive, nor ascending or descending. It is merely important that the value CNT be changed each time a new signature SGG is calculated.

The key K used to calculate the signature SGG of the block BLS can be different from that used to calculate the signatures SG1-SGn of the blocks BL1-BLn. Similarly, each of the blocks BL1-BLn can be signed with a key different from those used to sign the other blocks BL1-BLn. Furthermore, the blocks BL1-BLn and BLS can be ciphered before being sent outside the microcircuit SE, SE1. The blocks BL1-BLn and BLS received by the microcircuit are then deciphered by the latter before the program and data they contain are installed in the memory MEM2. The key used to cipher the blocks BL1-BLn and BLS can be different from the one(s) used to calculate the signatures SGG, SG1-SGn. Similarly, each block BLi can be ciphered with a key specific to it. The signature calculations and the ciphering operations can be performed using the circuit CRYC.

The memory MEM2 can be divided into blocks BLi, each block being associated with a modification indicator specifying whether or not the block has been modified since the last backup of the block in the memory LM, or since the last loading of the block from the memory LM. The indicators of modification of blocks BLi are updated upon each write in the memory MEM2. In some steps, for example at the end of the execution of an application by the microcircuit, the latter successively reads the modification indicators and executes steps S1 to S11 for each block BLi associated with a modification indicator indicating that the block has been modified.

The key K can be generated from a non-invertible function H applied to a first number stored in the memory MEM1 or MEM3. This number may for example be an identifier of the microcircuit, such as a serial number. The key K can be generated when executing the program stored in the memory MEM1. The non-invertible function can be a hashing function such as MD5, SHA1 or SHA256.

If several keys are necessary, for example to sign the block BLS, firstly, and, secondly, each of the blocks BL1-BLn, or to cipher these blocks, each key Ki can be generated by applying one or the other of the following formulas:

Ki=H(k/i), or (1)

Ki=H((Ki−1)/i), (2)

in which H is a non-invertible function such as a hashing function or a PUF function, i is a number that is modified, for example incremented, every time a key is generated from a predefined initial value, k/i represents a first number k concatenated to the number i, and Ki−1 is a key generated from the number i−1, the key K1 being equal to H(k/1). The first number k can be chosen equal to the number RND in FIGS. 7 and 8.

A series of keys may thus be generated in a deterministic manner, if the first number chosen k is still the same, for example the key K, and if the series of numbers i chosen is still the same for a given microcircuit. Series of derived keys may also be generated from a key Ki, and by reusing the series of numbers i, by applying the non-invertible function to each of the numbers of the series of numbers i, concatenated with the key Ki.

According to another embodiment, secret keys may also be generated by applying to a first number a first non-invertible function H1 to obtain a key root number, and by applying to this number, a second non-invertible function H2. Several secret keys may be generated by successively applying the function H1 to each result previously supplied by this function to obtain a series of derived key root numbers, and by applying the function H2 to each derived key root number thus obtained. Here again, the first number chosen k may always be the same, like the key K, to always generate the same series of keys Ki. Thus, a series of keys Ki may be generated by applying the following equations:

Si=H1(Si−1), and (3)

Ki=H2(Si) (4)

with S1=H1(k), S1 and Si being respectively the root numbers of the keys K1 and Ki. One and/or the other functions H1 and H2 can be a function PUF implemented by the circuit IFC. The first number S1 can be chosen equal to the number RND in FIGS. 7 and 8 or to the result of the function H1 applied to the number RND.

According to one embodiment, the circuit IFC comprises a physically unclonable circuit, implementing a physically unclonable non-invertible function PUF the operation of which is essentially unpredictable and indeterminable. Such a function can thus be used to identify a microcircuit or to generate a secret datum which can be used as key K or to generate the key K. The functions PUF are for example performed by a circuit sensitive to the manufacturing conditions of the circuit, so that there is very little probability of the respective functions PUF of two microcircuits providing an identical result, even though the two microcircuits come from a same production line. The function PUF is thus a non-invertible function equivalent to a hashing function such as SHA1, but characteristic of each microcircuit. The circuit IFC is used to generate one or more signature or ciphering keys.

FIG. 7 represents the circuit IFC, according to one embodiment. The circuit IFC comprises circuits PUC, IFC1 and IFC2. The circuit PUC implements a physically unclonable non-invertible function PUF the operation of which is essentially unpredictable and indeterminable. The circuit PUC has the particular feature of being physically unclonable. The circuit IFC1 is activated when the microcircuit is commissioned and every time the circuit must be reset in particular to generate a new key K to be used to sign the blocks BLi, BLS. The circuit IFC2 is activated every time the microcircuit is switched on to regenerate the key K that has been previously used to sign the blocks BLi, BLS backed up in the memory LM.

The circuit IFC1 comprises a logical operator of Exclusive OR-type XG1 and a generating circuit for generating an error correction datum ECC1. The operator XG1 is connected at output of the circuit PUC and of a random number generating circuit RNGN and provides a datum EXT that is thus equal to PN⊕RND, PN being the datum supplied by the circuit PUC, RND being a random number supplied by the circuit RNGN and “⊕” representing the Exclusive OR operator. The data RND and PN thus have the same size in number of bits. The circuit ECC1 receives the random number RND and provides an error correction datum ECW.

The circuit IFC2 comprises a logical operator of Exclusive OR type XG2 and an error correction circuit ECC2. The operator XG2 receives the datum EXT that has been sent to the microcircuit SE, as well as a datum PN′ coming from the circuit PUC. Given the properties of the circuit PUC, the datum PN′ is supposed to be identical or close to the datum PN that has been produced upon the commissioning of the microcircuit SE. Here “close” means identical to within a number of bits lower than half the number of bits of the data PN, PN′. The operator XG2 supplies a resulting datum RND′ to the circuit ECC2 which further receives the datum ECW that has been sent to the microcircuit SE. Thus, the datum RND′ is equal to PN′⊕EXT. The circuit ECC2 corrects the datum RND′ and thus restores the datum RND. It shall be noted that if the data PN and PN′ are identical, the operator XG2 directly supplies the datum RND, and the circuit ECC2 does not detect any error to be corrected and thus also supplies the datum RND.

The circuits ECC1 and ECC2 can implement different error correction algorithms such as BCH, Reed Solomon, or those based on the use of Hamming or Gray codes.

In the example of FIGS. 5 and 6, the data EXT and ECW are backed up in the memory LM following their generation, for example with the signature SGG in step S11. The data EXT and ECW are furthermore sent in steps S3 and S24 to the microcircuit to enable the latter to regenerate the key K, from the secret datum RND.

Certain error correction algorithms use an error correction datum which can be used alone to find the value of the datum to be corrected. Now, the datum ECW is sent outside the microcircuit SE1. For the datum RND to be kept secret whatever the error correction algorithm used, the circuit IFC can be modified in accordance with the one represented in FIG. 8.

According to another embodiment, the circuit IFC represented in FIG. 8 differs from the circuit IFC in that it comprises circuits IFC1′, IFC2′ different from circuits IFC1, IFC2. The circuit IFC1′ comprises Exclusive OR-type logical operators XG3, XG4 and the circuit ECC1. The operator XG3 receives a portion PN1 of the datum PN generated by the circuit PUC and the random datum RND, the portion PN1 having the same size as the datum RND. The operator XG3 supplies a datum EXT1. The circuit ECC1 supplies an error correction datum ECW from the datum RND. The operator XG4 receives another portion PN2 of the datum PN and the datum ECW. The operator XG4 supplies a datum EXT2 that is concatenated with the datum EXT1 to form the datum EXT. The data PN1, RND and EXT1 thus have a same size in number of bits. Similarly, the data PN2 and ECW have a same size. In this way, the datum ECW is transformed into the datum EXT2 before being sent outside the microcircuit SE.

The circuit IFC2′ differs from the circuit IFC2 in that the operator XG2 supplies both the datum RND′ and an error correction datum ECW from the datum EXT and from the datum PN′ supplied by the circuit PUC. As is the case in the circuit IFC2, the circuit ECC2 supplies the datum RND from the data RND′ and ECW. Although the data ECW and ECW may be different, they differ little given the properties of the function PUF implemented by the circuit PUC. It is thus likely that the number RND which is supplied by the circuit ECC2 will be close to the one that was generated when activating the circuit IFC1′ upon commissioning the microcircuit SE1, the word “close” having the same meaning as previously defined.

It further goes without saying that the functions implemented by the circuits represented on FIGS. 7 and 8 may also be implemented in software form, by a sequence of instructions executable by the processor PRC. It further goes without saying that any invertible logic function other than the Exclusive OR function may be used. Thus, any pair of logic functions (F1, F2) can be used instead of the Exclusive OR function (for F1 and F2), provided that the following relations are met for any pair of data (x,y) and for any datum PN:

y=F1(x,PN),

and

x=F2(y,PN). (5)

The key K can be chosen equal to the datum RND or be derived from the latter for example using a non-invertible function such as a hashing function like MD5 and SHA-1, or by applying the equations (1), (2) or (3) and (4). In this way, it is not necessary to provide a non-volatile memory in the microcircuit to store the key K.

Certain unclonable circuits implementing a function PUF may be sensitive to attacks by fault injection. Indeed, to give the datum supplied by such a circuit a certain stability, this datum can be processed by an error correction circuit. By forcing a bit to 0 at output of the unclonable circuit for example using a laser beam and by observing the response of the error correction circuit, it is possible to determine whether or not an error has been corrected. Depending on whether a response is observed or not, it is possible to deduce whether the bit modified by fault injection must be on 1 or 0. It is thus possible to deduce the datum normally supplied at output of the error correction circuit, by injecting faults on each of the output bits of the unclonable circuit. To ensure a certain stability of the value of the data it supplies, the unclonable circuit can be maintained in stable conditions, in particular of temperature. The discovery of the datum supplied by the unclonable circuit can enable the attacker to determine a secret datum such as an encryption key used by the microcircuit.

According to one embodiment, the circuit PUC of the circuit IFC represented in FIG. 3, 7 or 8 comprises means for modifying every time the circuit is used, a few bits of the value supplied by the function PUF implemented by the circuit, so as to ensure that the error correction circuit systematically corrects errors in each datum supplied by the unclonable circuit. The number of modified bits of each datum supplied is less than or equal to the number of incorrect bits that the error correction circuit is capable of correcting.

The modified bits may be bits added to the bits supplied by the function PUF that come from a random generator. The modified bits may be bits of which the polarity is inverted or forced to a certain value. The modified bits may also be randomly chosen. Modifications to the datum supplied by the function PUF can be introduced only once, for example upon the commissioning of the microcircuit implementing the function PUF, or every time the function PUF is activated.

FIG. 9 represents the circuit PUC, and in particular the function PUF implemented by this circuit and a bit output OB of the circuit PUC, according to one embodiment. Certain bit B output lines of the function PUF are coupled to a bit output OB of the circuit PUC through an inverter INV and a multiplexer MX1. The multiplexer MX1 receives at input the bit B and the bit B inverted by the inverter INV. The multiplexer MX1 is controlled by a random bit 11. Thus, the bit OB supplied at output of the circuit PUC corresponds either to the bit B supplied by the function PUB, or to this inverted bit depending on the value of the random bit 11. In the example in FIG. 9, if the bit 11 is on 0, the bit B is supplied at output of the circuit PUB without any change, if the bit 11 is on 1, the bit B is inverted.

According to one embodiment, all the bit output lines of the function PUF are coupled to a bit output of the circuit PUC through such a circuit comprising an inverter and a multiplexer. Each multiplexer MX1 is controlled by a respective bit of a random datum RN1. The number of bits on 1 (in the example in FIG. 9) of the datum RN1 is limited to the maximum number of bits of the datum coming from the function PUF, which may be modified, given the error correction capacities of the error correction circuit coupled at output of the circuit PUC.

It will be understood by those skilled in the art that the present invention is susceptible of various alternative embodiments and various applications. In particular, the method according to the present invention is not limited to the backup of data or of programs present in a volatile memory of a microcircuit, but can also be applied to data and/or programs stored in a non-volatile memory of the microcircuit, in particular when this memory has an insufficient capacity.

It will further be understood by those skilled in the art that the different embodiments previously presented are susceptible of various alternative embodiments and various applications, and may be implemented independently from each other, or combined in various ways other than those presented. In particular, this invention is not limited to NFC devices and microcircuits configured to perform NFC transactions, but can apply to any secure microcircuit.

Furthermore, the embodiments described with reference to FIGS. 7 and 8 may be implemented independently from the sequence of steps represented on FIGS. 5 and 6, in any circuit using a secret datum, and which must be capable of regenerating this datum from data stored in a non-secure memory.

Thus, this application also independently covers a method for generating and regenerating a master key and a microcircuit implementing such a method. This method comprises steps of:

generating a random datum RND and an error correction datum ECW from the random datum,

generating a master key K from the random datum,

obtaining a first secret datum PN, PN1 from an unclonable, substantially deterministic, non-invertible function PUF characteristic of the microcircuit, and

combining by a first invertible logic function the first secret datum and the random datum, to obtain a datum exportable EXT, EXT1 outside the microcircuit.

The regeneration of the master key comprises steps of:

obtaining a second secret datum PN′ from the function characteristic of the microcircuit, and

combining by a second logic function that is the inverse of the first logic function, the second secret datum and the exportable datum,

applying to the result RND′ of the second logic function an error correction process ECC2 using the error correction datum ECW, ECW′, to obtain the random datum, and

generating the signature key from the random datum.

According to one embodiment, the generation of the master key comprises steps of:

obtaining a third secret datum PN2 from the function PUF characteristic of the microcircuit, and

combining by the first logic function, the third secret datum and the error correction datum ECW, to obtain a second exportable datum EXT2,

the regeneration of the master key comprising steps of:

obtaining a fourth secret datum PN2′ from the function characteristic of the microcircuit, and

combining by the second logic function, the fourth secret datum and the second exportable datum, to obtain an error correction datum that is used by the error correction process ECC2, to obtain the random datum RND.

It will be understood that these features can be combined with other features described above in this description.

Similarly, the embodiments described in particular with reference to FIG. 9 can be implemented independently of the embodiments described with reference to FIGS. 7 and 8. In particular, provision may be made to modify certain bits of a datum supplied by a function PUF in any circuit implementing such a function, provided that the latter is coupled to an error correction function. Conversely, the function PUF implemented in the circuit PUC is not necessarily coupled to an error correction function. Other methods can indeed be implemented so as to “stabilize” the datum or data supplied by the function PUF. Indeed, provision may be made to activate the function PUF several times and to supply as output datum of this function an average value of all the data obtained following these activations.

Thus, this application also independently covers a method for generating a secret datum in a substantially deterministic, non-invertible manner, in a microcircuit, using an unclonable circuit characteristic of the microcircuit. This method comprises steps of generating a secret datum using such a function, of modifying bits in the secret datum, by inserting random bits or inverting bits into the secret datum, and of applying an error correction function to the secret datum, the extent of the modifications of bits in the secret datum being such that they can be corrected by the error correction function.

The rank of the modified bits, the value of the modified bits may be fixed or chosen randomly. The number of modified bits can also be fixed or chosen randomly within the limit of the error correction capacity of the error correction function.

It will be understood that these features can be combined with other features described above in this description.

1. A method for managing the memory of a secure microcircuit, comprising steps executed by the microcircuit of
forming a data block with executable code and/or data stored in a memory of the microcircuit, and to be backed up outside the microcircuit,
calculating a signature of the data block using a first signature key,
inserting the calculated signature of the data block into a signature block formed with signatures of data blocks sent outside the microcircuit,
obtaining a current value of a non-volatile counter internal to the microcircuit,
calculating a signature of the signature block associated with the current value of the internal counter, using a second signature key, and
sending outside the microcircuit, the data block, the signature block and the signature of the signature block.

2. The method according to claim 1, comprising steps executed by the microcircuit of:
sending a request for a signature block,
receiving in response a signature block together with a signature,
calculating a signature of the signature block associated with the current value of the internal counter, using the second signature key, and
if the calculated signature corresponds to the signature received:
forming a data block with executable code and/or data stored in the volatile memory of the microcircuit, and to be backed up outside the microcircuit,
calculating a signature of the data block, using the first signature key,
inserting the calculated signature of the data block into the signature block,
changing the current value of the internal counter,
calculating a new signature of the signature block associated with the new value of the internal counter, using the second signature key, and
sending outside the microcircuit, the data block, the signature block and the new signature of the signature block.

3. The method according to claim 2, comprising steps of:
if the calculated signature of the signature block corresponds to the signature received:
sending a request for a data block backed up outside the microcircuit,
receiving in response the requested data block,
calculating a signature of the data block received, using the first signature key, and
if the calculated signature of the data block corresponds to a signature of the data block located in the signature block, loading the data block into the volatile memory of the microcircuit.

4. The method according to claim 1, comprising a step of breaking down the volatile memory of the microcircuit into data blocks which may be backed up outside the microcircuit, in association with a signature of the data block, backed up in the signature block.

5. The method according to according to claim 1, wherein the first and second signature are read in a non-volatile memory of the microcircuit or regenerated from a secret datum supplied by a circuit of the microcircuit.

6. The method according to claim 1, wherein the first and second signature keys are identical.

7. The method according to claim 1, comprising a step of ciphering a data block or the signature block block, using a ciphering key, before sending it outside the microcircuit.

8. The method according to claim 7, wherein the ciphering key is identical to the first or the second signature key.

9. The method according to claim 1, wherein each block is signed and/or ciphered with a signature or ciphering key different from the signature and/or ciphering keys used for the other blocks.

10. The method according to claim 1, wherein each signature key is generated from a secret datum obtained by an unclonable, substantially deterministic, non-invertible function characteristic of the microcircuit, which, when combined with an error correction function or an averaging function, always provides the same secret datum.

11. The method according to claim 1, wherein the generation of each signature key comprises steps of:
generating a random datum and an error correction datum from the random datum,
generating the signature key from the random datum,
obtaining a first secret datum from an unclonable, substantially deterministic, non-invertible function characteristic of the microcircuit, and
combining by a first invertible logic function the first secret datum and the random datum, to obtain a datum exportable outside the microcircuit,
the regeneration of each signature key comprising steps of:
obtaining a second secret datum from the function characteristic of the microcircuit, and
combining by a second logic function that is the inverse of the first logic function, the second secret datum and the exportable datum,
applying to the result of the second logic function an error correction process using the error correction datum, to obtain the random datum, and
generating the signature key from the random datum.

12. he method according to claim 11, wherein the generation of each signature key comprises steps of:
obtaining a third secret datum from the function characteristic of the microcircuit, and
combining by the first logic function, the third secret datum and the error correction datum, to obtain a second exportable datum,
the regeneration of each signature key comprising steps of:
obtaining a fourth secret datum from the function characteristic of the microcircuit, and
combining by the second logic function, the fourth secret datum and the second exportable datum, to obtain an error correction datum that is used by the error correction process, to obtain the random datum.

13. The method according to claim 10, comprising a step of changing bits in the secret data supplied by the function characteristic of the microcircuit, by inserting random bits or inverting bits into the secret data, the extent of the bit changes in the secret data being such that they can be corrected by the error correction function.

14. A microcircuit comprising a processor and a volatile memory in which a program executed by the processor is stored, the microcircuit being configured to implement the method according to claim 1.

15. The microcircuit according to claim 14, comprising a rewritable, non-volatile storage capacity that is insufficient to store the programs or the operating system executed by the microcircuit.

16. The microcircuit according to claim 14, comprising a circuit implementing an unclonable, substantially deterministic, non-invertible function characteristic of the microcircuit.
